(19) United States
(12) Patent Application Publication
(10) Pub. No.: US 2009/0197649 A1
(43) Pub. Date: Aug. 6, 2009

(54) MOBILE PHONE WITH HEADSET DOCKING STATION

(75) Inventor: Matthew J. Ranney, Oakland, CA (US)

Correspondence Address: BEYER LAW GROUP LLP / REBELVOX, P.O. BOX 1687, Cupertino, CA, 95015-1687, US

(73) Assignee: REBELVOX, LLC, San Francisco, CA (US)

(21) Appl. No.: 12/026,436

(22) Filed: Feb. 5, 2008

(51) Int. Cl. H04M 1/06

(52) U.S. Cl. 455/569.1

(57) ABSTRACT

The present invention is directed to a mobile phone with a docking station to receive a headset. The mobile phone includes a housing and a docking station provided adjacent the housing. The apparatus also includes a headset that is configured to be removably housed in the docking of the mobile phone. A transceiver pair, including a transceiver provided on both the mobile phone and the headset respectively, enables signals to be sent back and forth between the mobile phone and the headset. During operation, the headset is optionally removed from the docking station and placed on the user's ear. After use, the headset may be docked within the housing of the headset. The transceiver pair may communicate wirelessly or through one or more electrical wires.

### BACKGROUND

1. Field of the Invention

The present invention relates to telecommunications, and more particularly, to a mobile phone with an integrated docking station to receive a headset.

2. Description of Related Art

Mobile or “cellular” phones have become extremely popular in recent years. More and more people are using mobile phone service for personal and business telecommunications. In addition to their land-line phone use at both home and work, many people now use mobile phones. In fact cell phones have now become so popular, many people are using their mobile phones exclusively, replacing legacy land-line phones altogether

With the ever-expanding use of mobile phones, mobile phone makers have been designing and offering more and more functionality, features and accessories. One popular accessory now commonly used with mobile phones is headsets.

A headset is a device that is used in cooperation with a mobile phone. Headsets, which include a microphone and speaker, are typically attached to the ear of the mobile phone user. During a phone conversation, the user speaks into the microphone of the headset while incoming voice is rendered on the speaker of the headset, replacing the use of the speaker and the microphone of the phone itself. The headset connection to the mobile phone is typically either wireless (e.g., Bluetooth) or plugged into the phone using a wire.

Since the headset is attached to the ear of the user, the user does not have to hold the mobile phone while using it. As a result, the phone can be placed in the pocket or other convenient location, while the user's hands are free. Headsets are therefore very popular with people who use their mobile phones while driving, conduct mobile phone conversations while typing on the keyboard of their computer, or perform other tasks with their hands while conducting a phone conversation.

A problem with headsets is there is often no convenient place to store them when they are not in use. For example if a person uses a headset, they will often have to place it in their pocket or briefcase while it is not in use. In the car, the headset is typically stored in the glove box, a cup holder, or some other storage location. Headsets are therefore often forgotten, lost or misplaced. Currently there is no known way to store a headset within the housing of a mobile phone itself.

### SUMMARY OF THE INVENTION

The present invention is directed to a mobile phone with a docking station to receive a headset. The mobile phone includes a housing and a docking station associated within the housing. The apparatus also includes a headset that is configured to be removably housed in the docking of the mobile phone. A transceiver pair, including a transceiver provided on both the mobile phone and the headset respectively, enables audio and other control signals to be sent back and forth between the mobile phone and the headset. During operation, the headset may be removed from the docking station and placed on the user's ear. After use, the headset may be docked within the housing of the headset. In various embodiments, the transceiver pair may communicate either wirelessly or through one or more electrical wires.

### BRIEF DESCRIPTION OF THE DRAWINGS

The invention may best be understood by reference to the following description taken in conjunction with the accompanying drawings, which illustrate specific embodiments of the present invention.

FIGS. 1A and 1B are diagrams of a mobile phone with a docking station for a headset according to one embodiment of the present invention.

FIG. 2 is a diagram of a wire connecting the mobile phone and the headset according to a second embodiment of the present invention.

FIGS. 3A and 3B are diagrams of a mobile phone with a docking station for a headset according to a third embodiment of the present invention.

FIGS. 4A and 4B are diagrams of a mobile phone with a docking station for a headset according to yet another embodiment of the present invention.

FIGS. 5A and 5B are diagrams of a wireless and a wired connection between the mobile phone and the headset of the present invention.

FIG. 6 illustrates power circuitry provided in both the mobile phone and headset of the present invention.

It should be noted that like reference numbers refer to like elements in the figures.

### DETAILED DESCRIPTION OF SPECIFIC EMBODIMENTS

The present invention will now be described in detail with reference to various embodiments thereof as illustrated in the accompanying drawings. In the following description, specific details are set forth in order to provide a thorough understanding of the present invention. It will be apparent, however, to one skilled in the art, that the present invention may be practiced without using some of the implementation details set forth herein. It should also be understood that well known operations have not been described in detail in order to not unnecessarily obscure the present invention.

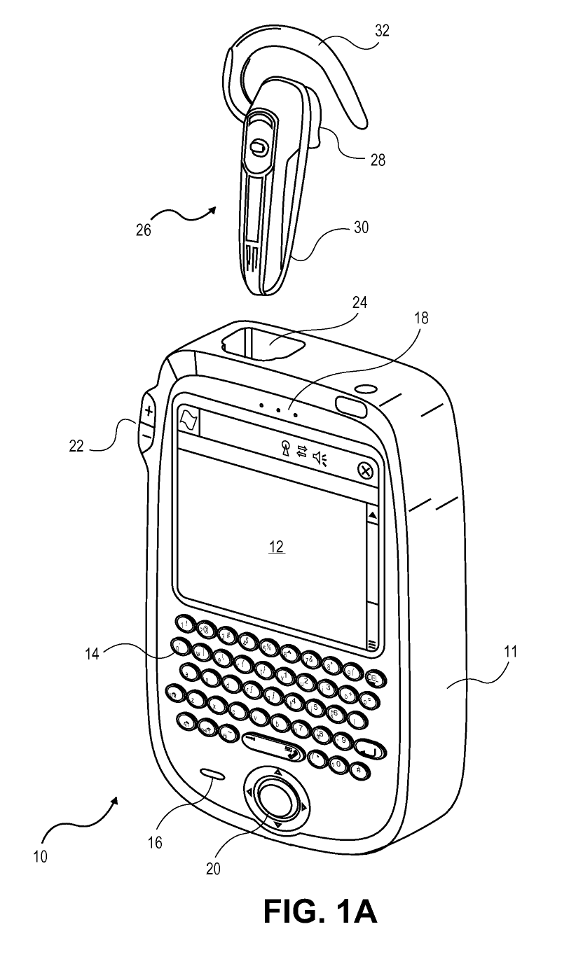

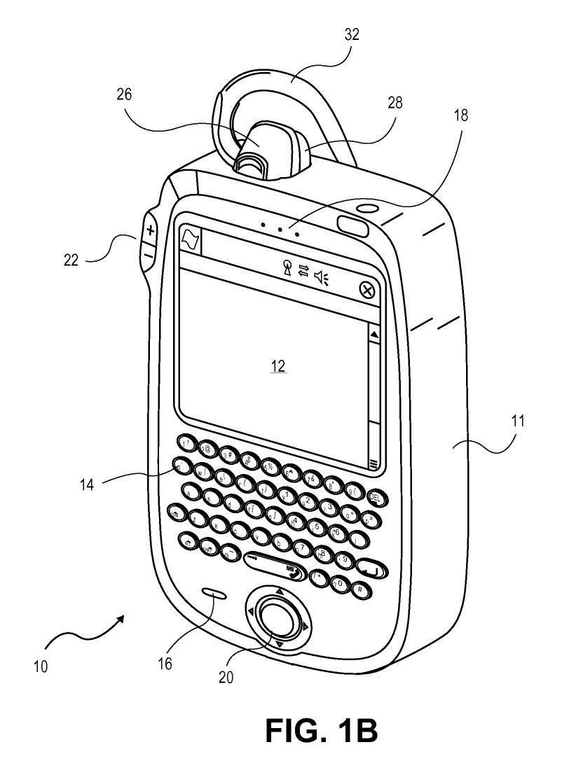

Referring to FIGS. 1A and 1B, diagrams of a mobile phone with a docking station for a headset according to one embodiment of the present invention are shown. The mobile phone 10 includes a housing 11, display screen 12, an alpha and/or numerical keypad 14, microphone 16, a speaker 18, a display controller 20, and various other controls such as volume control 22. The mobile phone 10 also includes a docking station 24 integrally formed within the housing 11. The docking station 24 is a recess formed in the housing 11 and is shaped to receive and accommodate a headset 26. The headset 26 includes a speaker 28, a microphone 30, and an earpiece 32. As illustrated in FIGS. 1A and 1B, the headset 26 is intended to be removably housed within the docking station 24. In FIG. 1A, the headset 26 is illustrated removed from the docking station 24. FIG. 1B shows the headset 26 inserted into the docking station 24.

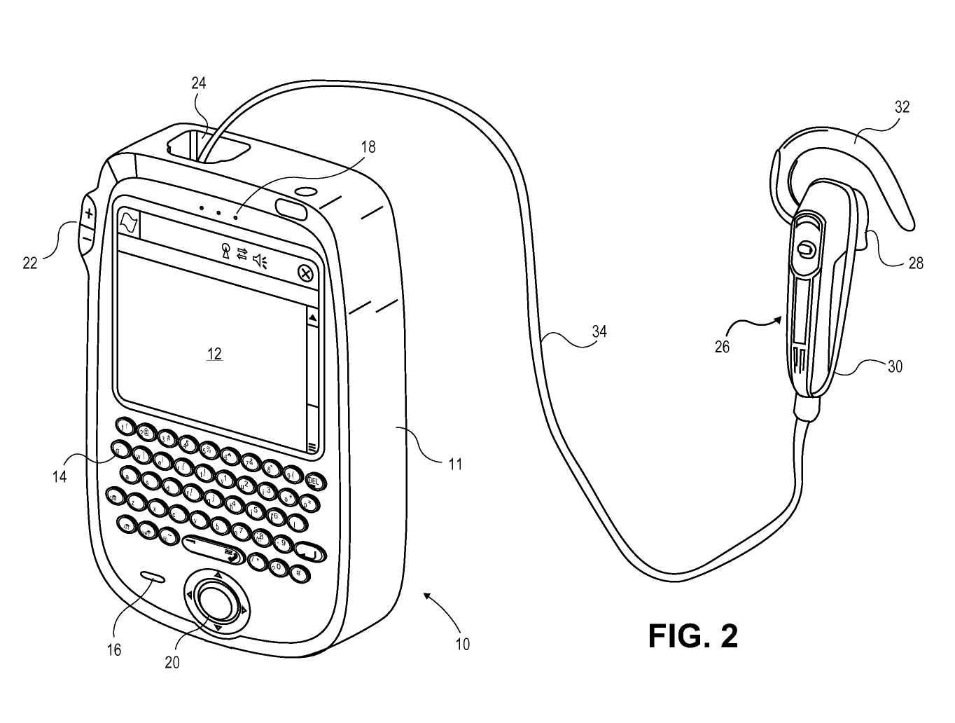

Referring to FIG. 2, a diagram of a wire connecting the mobile phone and the headset according to another embodiment of the present invention is shown. In this embodiment, a retractable wire 34 mechanically connects the headset 26 to the housing 11 of the mobile phone 10. Although not entirely visible in the figure, the wire 34 is connected at and retracts from inside the docking station 24. When the headset 26 is housed in the docking station 24, the wire 34 spools within the housing 11. As the headset 26 is removed, the wire 34 un-spools and extends out from the docketing station 24, allowing the headset 26 to be used, while remaining tethered to the mobile phone 10. In one embodiment, the wire 34 may provide electrical (i.e., voice) and other control signals between the mobile phone 10 and the headset 26. In an alternative embodiment, the wire 34 may simply provide a mechanical connection between the headset 26 and the mobile phone 10, while audio and control signals are transmitted between the two wirelessly.

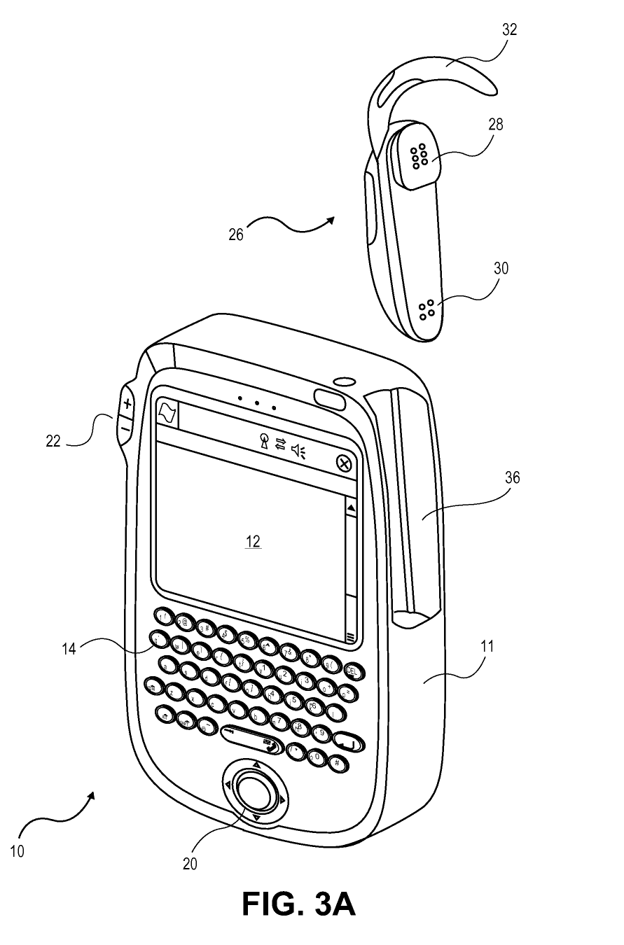

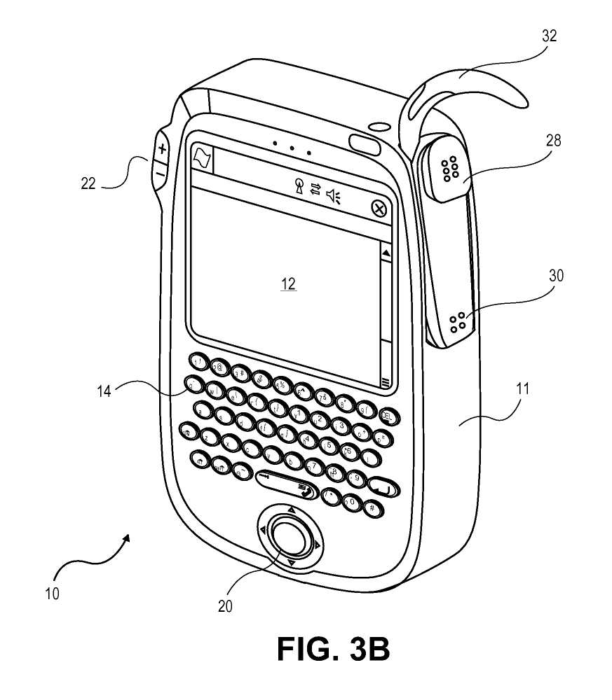

Referring to FIGS. 3A and 3B, diagrams of a mobile phone with a docking station for a headset according to another embodiment of the present invention are shown. In this embodiment, the docking station 36 is provided on a side of the housing 11 of the mobile phone 10, as best illustrated in FIG. 3A. With this arrangement, the speaker 28 and the microphone 30 are exposed when the headset 26 is inserted into the docking station 36, as best illustrated in FIG. 3B. As described in more detail below, this allows the speaker 28 and microphone 30 of the headset 28 to be used in lieu of the microphone 16 and the speaker 16 of the mobile phone 10, even when the headset 26 is inserted into the docking station 36. For the sake of illustration, the microphone 16 and the speaker 18 of the mobile phone 10 are removed from the figure. But it should be understood that the removal of these items from the mobile phone is optional. In embodiments where speakers and microphones are provided on both the headset 26 and the housing 11 of the mobile phone 12, the user has the option of using either. It should be noted that in the embodiment illustrated, the docking station 36 is provided on the right hand side of the phone. In other embodiments, the docking station can be provided on the left side of the mobile phone, as well as either the front or back sides of the mobile phone.

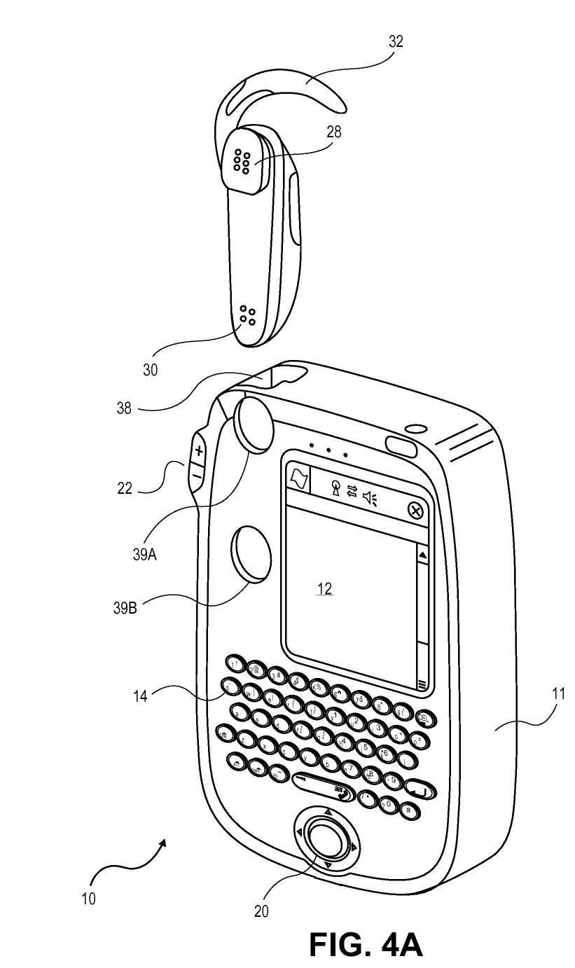

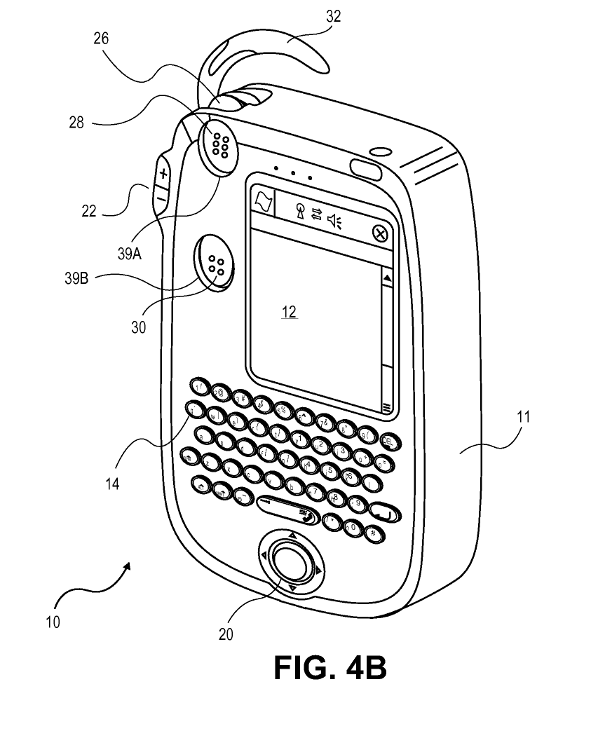

Referring to FIGS. 4A and 4B, diagrams of a mobile phone with a docking station for a headset according to another embodiment of the present invention are shown. As best illustrated in FIG. 4A, the docking station 38 is provided on one side of the phone. Two recess regions 39A and 39B are provided on the side surface of the mobile phone 10, just below the opening of the docking station 38. The two openings are positioned to coincide with the location of the speaker 28 and the microphone 30 of the headset 26 when inserted into the docking station 38, as best illustrated in FIG. 4B. In the embodiment shown, the recess regions 39A and 39B for providing an opening for the speaker 28 and microphone 30 are provided on the front surface of the mobile phone 10. In an alternative embodiment, the recess regions may be provided on the back surface or the phone as well as possibly the two side or top and bottom surfaces.

In various embodiments, the headset 26 and the mobile phone 10 may communicate with each other either wirelessly or through a wired connection. Each embodiment is described in more detail below.

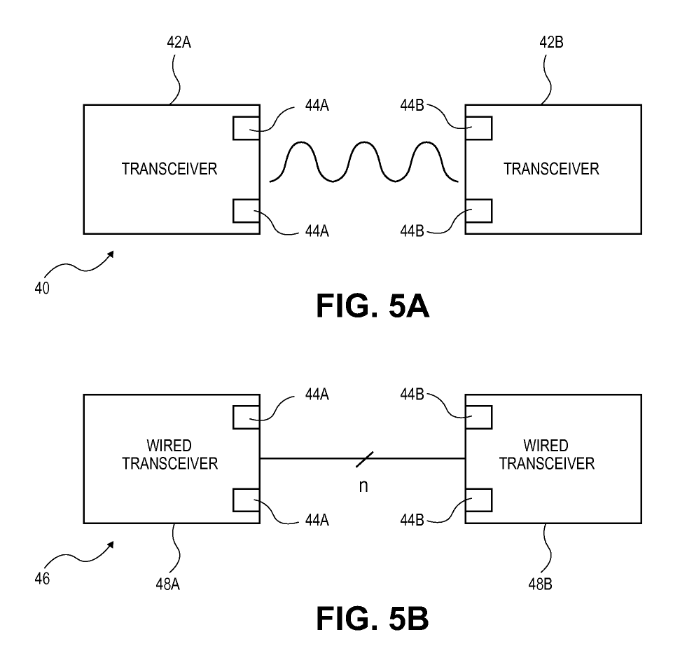

Referring to FIG. 5A, a wireless connection between the headset 26 and the mobile phone 10 is shown. The wireless connection 40 includes a wireless transceiver pair 42A and 42B provided on the mobile phone 10 and headset 26 respectively. In one embodiment, the wireless transceiver pair implements Bluetooth wireless technology for transmitting voice and other control signals between the headset 26 and the mobile phone 10. As Bluetooth wireless technology is well known in the art, a detailed explanation is not provided herein. The transceiver pair 42A and 42B each further include one or more contacts 44A and 44B. When the headset 26 is inserted in either docking station 24 or 36, the contact pairs 44A and 44B contact and are in electrical communication with each other. In this way, voice and other control signals that would otherwise be transmitted wirelessly are transferred between the transceiver pair 42A and 42B by a direct electrical connection when the headset 26 is in the docking station. The contacts 44A and 44B thus allow the speaker 28 and microphone 30 of the headset 26 to be used in lieu of the same on the mobile phone 10, when the headset 26 is docked in the docking station 36.

Referring to FIG. 5B, a wired connection between the headset 26 and the mobile phone 10 is shown. The wired connection 46 includes a wired transceiver pair 48A and 48B provided on the mobile phone 10 and headset 26 respectively. The two transceivers 48A and 48B are connected by electrical wire with one or more (n) conductors. The transceiver pair 48A and 48B also each optionally include one or more contacts 44A and 44B, which operate as described above.

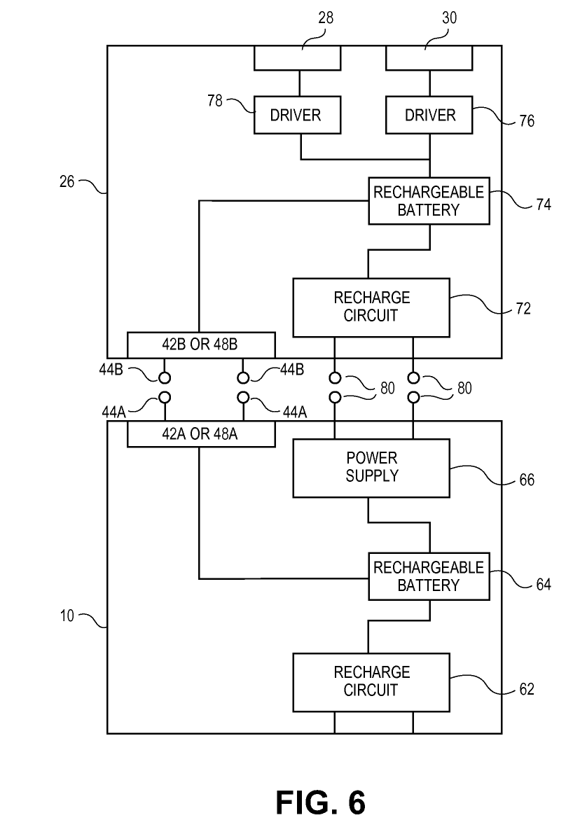

FIG. 6 illustrates power circuitry provided in both the mobile phone and headset of the present invention. The power circuitry on the mobile phone 10 includes a recharge circuit 62, a rechargeable battery 64, a power supply circuit 66, and a transceiver (either 42A or 48A). The power circuitry in the headset 26 includes a recharge circuit 72, a rechargeable battery 74, transceiver (either 42B or 48B), and driver circuits 76 and 78 to drive the speaker 30 and microphone 28 respectively. Contacts 80 electrically connect the power supply and the recharge circuit 72 when the headset 26 is docked in the docking station (either 24 or 36).

During operation, the user of the mobile phone 10 periodically plugs the phone into a wall outlet or other power source. While plugged in, the recharge circuit 62 charges the battery 64 with the power provided from the power source. The battery 64 is used to provide electrical power for the mobile phone 10, including the transceiver circuit 42A or 48A, as is well known in the art.

When the headset 26 is inserted into the docking station, the power supply 66 is connected to the recharge circuit 72 through the contacts 80. The recharge circuit 72 charges the battery 74 from the power supply 66 during the coupling. The battery 74 in turn is used to provide power to the drivers 76, 78 and the transceiver 42B or 42B. By docking the headset 26 in the housing 11 of the phone 10, the battery 74 can be continually charged for operation.

Although many of the components and processes are described above in the singular for convenience, it will be appreciated by one of skill in the art that multiple components and repeated processes can also be used to practice the techniques of the present invention. Further, while the invention has been particularly shown and described with reference to specific embodiments thereof, it will be understood by those skilled in the art that changes in the form and details of the disclosed embodiments may be made without departing from the spirit or scope of the invention. For example, rather than integrally forming the docking station in the body of the mobile phone, accommodations an be made to attach or otherwise attach the headset to the body of the phone. It is therefore intended that the invention be interpreted to include all variations and equivalents that fall within the true spirit and scope of the present invention.

What is claimed is:

1. An apparatus, comprising:
a mobile phone having a housing;
a docking station associated with the housing of the mobile phone;
a headset configured to be removably housed in the docking station associated with the housing of the mobile phone; and
a transceiver pair including a first transceiver and a second transceiver provided on the mobile phone and the headset respectively, the transceiver pair configured to enable audio signals to be sent back and forth between the mobile phone and the headset.

2. The apparatus of claim 1, wherein the docking station is shaped to accommodate the headset.

3. The apparatus of claim 1, wherein the transceiver pair is a wireless transceiver pair configured to wirelessly send audio signals back and forth between the mobile phone and the headset.

4. The apparatus of claim 3, wherein the wireless transceiver pair is a Bluetooth wireless transceiver pair.

5. The apparatus of claim 1, wherein the transceiver pair is connected by one or more electrical wires connected between the headset and the mobile phone.

6. The apparatus of claim 1, further comprising a retractable wire mechanically coupling the headset to the mobile phone housing.

7. The apparatus of claim 1, wherein the electrical signals are voice signals.

8. The apparatus of claim 1, wherein the electrical signals are control signals.

9. The apparatus of claim 1, wherein the headset includes a microphone and speakers.

10. The apparatus of claim 1, wherein the headset includes an earpiece configured to secure the headset to the ear of a user.

11. The apparatus of claim 1, wherein the mobile phone further comprises: a
rechargeable battery;
a recharge circuit configured to recharge the rechargeable battery;
a power supply connected to the rechargeable battery, and
one or more first electrical contacts connected to the power supply.

12. The apparatus of claim 11, wherein the headset further comprises:
a second rechargeable battery;
a second recharge circuit, coupled to the second rechargeable battery, and
one or more second electrical contacts connected to the second recharge circuit,
whereby the second rechargeable battery in the headset is charged by the power supply in the mobile phone through the one or more first and second electrical contacts which are configured to contact one another when the headset is housed in the docking station of the mobile phone.

13. The apparatus of claim 1, further comprising one or more contacts provided on the mobile phone and the headset respectively and which are configured to contact one another to electrically couple the first transceiver and the second transceiver when the headset is housed in the docking station of the mobile phone.

14. The apparatus of claim 13, wherein the transceiver pair are further configured to communicate with one another through the one or more contacts when the headset is housed in the docking station of the mobile phone, enabling the headset microphone and speaker to be used when the headset is housed in the docking station of the mobile phone.

15. The apparatus of claim 14, wherein the docking station is provided on an exterior side of the housing of the mobile phone so that the microphone and speaker of the headset may be exposed and used when the headset is housed in the docking system.

16. The apparatus of claim 15, wherein the speaker of the headset is the only speaker provided on the mobile phone and headset.

17. The apparatus of claim 16, wherein the microphone on the headset is the only microphone provided on the mobile phone and headset.

18. The apparatus of claim 1, wherein the mobile phone further comprises a microphone and a speaker.

19. The apparatus of claim 18, wherein the headset further comprises a second microphone and a second speaker.

20. The apparatus of claim 1, wherein the docking station is integrally formed within the housing of the mobile phone.

21. The apparatus of claim 1, wherein the housing of the mobile phone has a recess opening positioned to coincide with a speaker of the headset when the headset is housed in the docking station.

22. The apparatus of claim 1, wherein the housing of the mobile phone has a recess opening positioned to coincide with a microphone of the headset when the headset is housed in the docking station.
